(19) United States
(12) Patent Application Publication
(10) Pub. No.: US 2025/0389286 A1
(43) Pub. Date: Dec. 25, 2025

(54) READILY-OPERABLE HYDRAULIC CYLINDER

(71) Applicants: INTRADIN (HUZHOU) INTELLIGENT TECHNOLOGY CO., LTD., Huzhou (CN); INTRADIN (HUZHOU) PRECISION TECHNOLOGY CO.,LTD., Huzhou (CN)

(72) Inventors: Jun LEI, Huzhou (CN); Lingjiang MU, Huzhou (CN)

(21) Appl. No.: 19/305,673

(22) Filed: Aug. 20, 2025

(30) Foreign Application Priority Data
Jun. 11, 2025 (CN) 202521189444.4

(51) Int. Cl. F15B 15/14; F15B 15/20

(52) U.S. Cl. CPC F15B 15/1428; F15B 15/1447; F15B 15/204

(57) ABSTRACT

A readily-operable hydraulic cylinder, including a housing composed of a base and a first cylinder barrel. A valve body is fixedly provided in the housing. A second cylinder barrel is fixedly provided at an upper end of the valve body, and is located inside the first cylinder barrel. A piston rod is slidably provided inside the second cylinder barrel. A first piston is slidably and vertically arranged inside the base. A joint is provided below the valve body. A second piston is slidably provided inside the joint. A first pressurizing chamber is formed between the first piston, the valve body, the joint and the housing. A second pressurizing chamber is formed between the second piston, the joint and the valve body.

### CROSS-REFERENCE TO RELATED APPLICATIONS

This application claims the benefit of priority from Chinese Patent Application No. 202521189444.4, filed on Jun. 11, 2025. The content of the aforementioned application, including any intervening amendments made thereto, is incorporated herein by reference in its entirety.

### TECHNICAL FIELD

This application relates to hydraulic cylinders, and more particularly to a readily-operable hydraulic cylinder.

### BACKGROUND

Chinese patent publication No. 118598017 A (filed on Jun. 11, 2024 and published on Sep. 6, 2024) discloses a 1500-LB lifting platform motorcycles, including a frame and a hydraulic mechanism. The frame includes a base. A first support is fixed at a front end inside the base through a first pin, and a second support is fixed at a rear end inside the base through a second pin. A lifting arm is inserted inside the second support. A pullable handle is fixedly mounted on a rear-side outer surface of a top end of the lifting arm. Outer surfaces of two sides of the lifting arm are each provided with a safety bracket. Three safety pins are fixedly welded on outer surfaces of two sides of the base. Top ends of the second support and the first support are each provided with a platform. A load-bearing table is fixedly welded to an inner side of the base. A hydraulic mechanism is arranged on an upper side of the load-bearing table. The hydraulic mechanism includes an oil tank, in which a hydraulic cylinder is arranged. A piston rod is inserted inside the hydraulic cylinder. A pump body is arranged on a right side of the oil tank, and a pump core is inserted inside the pump body. A press handle is fixedly mounted at a top end of the pump core. A return spring is sleeved on an outer surface of the pump body. A lifting pedal is inserted inside the press handle. A tightening screw is arranged at a bottom end of the piston rod inside the oil tank. A speed-limiting spring is arranged on a right side of the tightening screw. A 6 mm steel ball is movably fitted to an upper side of the speed-limiting spring. An oil return pedal is provided at a bottom end of the oil tank. An oil return push rod is movably fitted to a right side of the oil return pedal. An ejector pin is movably fitted to a right side of the oil return push rod. A high-pressure steel ball is movably fitted to a right side of the ejector pin.

The above-mentioned hydraulic mechanism has the following drawback in the practical operation. It is required to step on the lifting pedal to raise the piston rod, while it is required to step on the oil return pedal to retract the piston rod (that is, the two processes are separately performed on two different pedals), making the operation complicated.

### SUMMARY

An object of the disclosure is to provide a readily-operable hydraulic cylinder, in which upward and downward movements of a piston rod can be achieved simply by depressing a foot-operated assembly, thereby simplifying the operation.

Technical solutions of the present disclosure are described as follows.

A readily-operable hydraulic cylinder, comprising:
a housing composed of a base and a first cylinder barrel;
wherein a valve body is fixedly provided in the housing; a second cylinder barrel is fixedly provided at an upper end of the valve body, and is located inside the first cylinder barrel; and an oil storage chamber is formed between the first cylinder barrel, the second cylinder barrel and the valve body;
a piston rod is slidably provided inside the second cylinder barrel; and a pressure chamber is formed between the piston rod, the second cylinder barrel and the valve body;
a first piston is slidably and vertically arranged inside the base; and the first piston is located below the valve body, and is configured to be driven by a foot-operated assembly to move upward;
a joint is provided below the valve body; a second piston is slidably provided inside the joint; a first pressurizing chamber is formed between the first piston, the valve body, the joint and the housing; and a second pressurizing chamber is formed between the second piston, the joint and the valve body;
the first pressurizing chamber is communicated with the second pressurizing chamber through a first oil passage;
a second oil passage, an oil inlet passage, and an oil return passage are provided inside the valve body; the oil storage chamber is communicated with the first pressurizing chamber through the second oil passage; the second pressurizing chamber is communicated with the pressure chamber through the oil inlet passage; and the second pressurizing chamber is communicated with the oil storage chamber through the oil return passage;
a first valve is provided in the first oil passage, wherein the first valve is a check valve; a second valve is provided in the second oil passage; a third valve is provided in the oil inlet passage; and a fourth valve is provided in the oil return passage, wherein the fourth valve is a check valve;
in response to a case that the piston rod is required to move upward, the foot-operated assembly is configured to drive the first piston to move upward to compress the first pressurizing chamber, such that an oil pressure in the first pressurizing chamber is increased to cause the second valve to be closed to block the second oil passage and cause the first check valve to be opened to open the first oil passage, so as to allow a hydraulic oil in the first pressurizing chamber to enter the second pressurizing chamber through the first oil passage;
during an upward movement of the first piston, the first piston is configured to drive the second piston to move upward to compress the second pressurizing chamber, such that an oil pressure in the second pressurizing chamber is increased to cause the third valve to be opened to open the oil inlet passage, so as to allow a hydraulic oil in the second pressurizing chamber to enter the pressure chamber through the oil inlet passage; and
in response to a case that the piston rod is required to move downward, the foot-operated assembly is configured to drive the first piston to move upward until the second piston pushes the third valve to open the oil inlet passage and the fourth valve to open the oil return passage, such that a hydraulic oil in the pressure chamber flows through the oil inlet passage, the second pressurizing chamber and the oil return passage back into the oil storage chamber.

In some embodiments, a valve core hole is provided in the valve body; a side wall of the valve core hole is provided with an oil inlet hole and an oil outlet hole opposite to each other; and the oil inlet hole and the oil outlet hole are each communicated with the oil return passage; and
a regulating valve core is slidably provided in the valve core hole along an axial direction of the valve core hole;
a portion of the valve core hole at a first side of the regulating valve core is communicated with the oil storage chamber, and a portion of the valve core hole at a second side of the regulating valve core is communicated with the oil inlet passage;
the regulating valve core comprises a truncated-cone section arranged opposite to the oil inlet hole; and
a diameter of the truncated-cone section is increasing from the first side of the regulating valve core to the second side of the regulating valve core.

In some embodiments, a first spring is provided in the valve core hole to offer an elastic force to cause the regulating valve core to move toward a side where the oil inlet passage is located;
the regulating valve core further comprises a first cylindrical section whose diameter is equal to a minimum diameter of the truncated-cone section and a second cylindrical section whose diameter is equal to a maximum diameter of the truncated-cone section;
the first cylindrical section is connected to a portion of the truncated-cone section having the minimum diameter, and the second cylindrical section is connected to a portion of the truncated-cone section having the maximum diameter;
the regulating valve core is provided with a first annular projection and a second annular; and the first annular projection and the second annular projection abut against the side wall of the valve core hole for sealing; and
the first annular projection is located on a side of the first cylindrical section away from the truncated-cone section, and the second annular projection is located on a side of the second cylindrical section away from the truncated-cone section.

In some embodiments, the valve core hole is axially arranged in a vertical direction and includes a first valve core hole and a second valve core hole. The first valve core hole is larger than the second valve core hole. The regulating valve core and the first spring are provided in the first valve core hole. An upper end of the first valve core hole is communicated with the oil storage chamber. A sliding post is provided inside the regulating valve core. An upper end of the sliding post is inserted into the regulating valve core, and a lower end of the sliding post is slidably provided in the second valve core hole. A lower end of the second valve core hole is communicated with the oil inlet passage.

In some embodiments, a first O-ring is sleeved outside the sliding post to seal a gap between the sliding post and the second valve core hole.

In some embodiments, the second valve comprises a first valve core configured to open and block the second oil passage and a second spring configured to elastically reset the first valve core toward a side where the oil storage chamber is located;

a mounting hole is provided in the valve body; a second valve core is slidably provided in the mounting hole; a portion of the mounting hole at a side of the second valve core is communicated with the pressure chamber; and an end of the second valve core away from the pressure chamber is connected to the first valve core; and in response to a case of overloading, the second valve core is configured to push the first valve core to open the second oil passage.

In some embodiments, the valve body is further provided with a mounting sleeve; a pushing shaft is slidably provided in the mounting sleeve, and is located between the second valve core and the first valve core; and the pushing shaft is sleeved with a third spring configured to cause the pushing shaft to move toward a side where the second valve core is located.

In some embodiments, the mounting hole is axially arranged in the vertical direction. An upper end of the mounting sleeve has an opening. A mounting hole is provided on a lower end surface of the mounting sleeve for the pushing shaft to extend therethrough. A mounting flange is provided at an upper end of the pushing shaft. An upper end of the third spring is configured to abut against the mounting flange, and a lower end of the third spring is configured to abut against the lower end surface of the mounting sleeve.

In some embodiments, a second O-ring is sleeved outside the second valve core, and is configured to seal a gap between the second valve core and the mounting hole.

In some embodiments, an oil discharge passage is provided in the first valve core, and is configured to communicate the oil storage chamber with the first pressurizing chamber.

In some embodiments, the first valve core is axially arranged in the vertical direction. The oil discharge passage includes a first hole extending along an axial direction of the first valve core and a second hole extending perpendicular to the axial direction of the first valve core. The first hole is vertical, and the second hole is horizontal. The second hole has a diameter of 0.6-0.8 mm. The first hole is a stepped hole, including a third hole located above and a fourth hole located below the third hole. The fourth hole is larger than the third hole. The second hole is connected to a side wall of the third hole. A diameter of the third hole is 1.0-1.4 mm, and a diameter of the fourth hole is 2.0-2.4 mm.

In some embodiments, the third valve comprises a first valve core configured to open and block the oil inlet passage and a fourth spring configured to cause the first valve core to reset toward a side where the second pressurizing chamber is located;
an end of the first valve core adjacent to the second pressurizing chamber is configured to extend out of the valve body;
the fourth valve comprises a second valve core configured to open and block the oil return passage and a fifth spring configured to cause the second valve core to reset toward the side of the second pressurizing chamber;
an end of the second valve core adjacent to the second pressurizing chamber is configured to extend out of the valve body;
an elastic force of the fourth spring is smaller than that of the fifth spring; and
in response to a case that the second piston moves upward to push the first valve core and the second valve core to move into the valve body, the first valve core is configured to open the oil inlet passage, and the second valve core is configured to open the oil return passage.

In some embodiments, the first piston is configured as an upward-opening hollow cylinder;
a mounting seat is provided inside the first piston; and the mounting seat comprises a bottom plate and a sleeve portion on the bottom plate;
an inner end surface of the first piston is configured to recess to form a groove;
the bottom plate is provided with an oil passage hole configured to communicate the first pressurizing chamber with the groove;
an upper end of the sleeve portion is fixedly connected to a lower end of the second piston, and is provided inside the second piston;
the mounting seat is provided with a through hole configured to communicate the groove with the second pressurizing chamber;
the oil passage hole, the groove and the through hole together form the first oil passage;
the first valve is provided in the through hole;
a sixth spring is sleevedly provided on the sleeve portion, and is located between the second piston and the bottom plate; and
in response to a case that the second piston pushes the third valve and the fourth valve, a lower end of the joint abuts against the sixth spring.

In some embodiments, the sleeve portion is threadedly engaged with the second piston.

In some embodiments, the through hole is axially arranged in the vertical direction. The first valve includes a steel ball provided on the mounting seat for opening and blocking the through hole, and a seventh spring configured to offer an elastic force to cause the steel ball to reset downward.

In some embodiments, the sixth spring is a Belleville-spring washer.

In some embodiments, a third O-ring is sleeved outside the first piston to seal a gap between the first piston and the base. A fourth O-ring is sleeved outside the second piston to seal a gap between the second piston and the joint.

In some embodiments, a lower end of the valve body is threadedly connected to an upper end of the base. An upper end of the valve body is provided inside the first cylinder barrel. A fifth O-ring is sleeved outside the valve body to seal a gap between the valve body and the base. A sixth O-ring is sleeved outside the valve body to seal a gap between the valve body and the first cylinder barrel.

In some embodiments, an eighth spring is sleeved outside the joint; and an upper end of the eighth spring is configured to abut against the valve body, and a lower end of the eighth spring is configured to abut against the bottom plate.

In some embodiments, a bottom frame is provided below the base;
the foot-operated assembly comprises a first hinged seat; a lower end of the first hinged seat is hinged to the bottom frame; and an upper end of the first hinged seat is hinged to a second hinged seat;
a first end of the second hinged seat is hinged to the first piston, and a second end of the second hinged seat is hinged to an end of a pedal;
a torsion spring is sleeved on a hinge shaft between the second hinged seat and the pedal to cause the pedal to rotate upward; and
a limit plate is provided at the end of the pedal hinged to the second hinged seat to abut against and limit the second hinged seat.

In some embodiments, the first piston further includes a connecting sleeve provided below the cylindrical body (i.e., the main body of the first piston). The base is provided with two waist-shaped holes arranged opposite to each other, where a length direction of the waist-shaped hole is arranged to be the vertical direction. The second hinged seat includes two hinged plates respectively provided on two sides of the base and a connecting plate connecting the two hinged plates. A hinge shaft between the second hinged seat and the first piston sequentially passes through one of the hinged plates, one of the waist-shaped holes, the connecting sleeve, the other of the waist-shaped holes and the other of the hinged plates.

In some embodiments, the bottom frame includes a first mounting plate and two second mounting plates. The first mounting plate is horizontal, and the second mounting plates are vertical. Each second mounting plate is provided with two mounting lugs. A lower end of the first hinged seat is hinged to one of the mounting lugs, and the other mounting lug is configured to extend into the base to be hinged to the base. A gap of 0.8-1.2 mm is provided between a bottom surface of the base and the second mounting plates.

In some embodiments, a front-end cover is provided at an upper end of the first cylinder barrel. The front-end cover includes a first sealing portion and a second sealing portion. The first sealing portion is provided inside the first cylinder barrel. An outer side wall of the first sealing portion is in sealing contact with an inner side wall of the first cylinder barrel. An upper end of the second cylinder barrel is provided inside the second sealing portion. An inner side wall of the second sealing portion is in sealing contact with an outer side wall of the second cylinder barrel. An upper end of the piston rod is configured to extend out of the front-end cover. An outer side wall of the piston rod is configured to abut against an inner side wall of the front-end cover for sealing.

In some embodiments, a connecting portion is provided at a middle section of an upper end of the valve body. The upper end of the second cylinder barrel is threadedly connected to the second sealing portion, and a lower end of the second cylinder barrel is threadedly connected to the connecting portion. A limit projecting edge is provided on a periphery of the first sealing portion. The first cylinder barrel is axially limited between the limit projecting edge and the base.

In some embodiments, a seventh O-ring is sleeved outside the first sealing portion to seal a gap between the first cylinder barrel and the first sealing portion. An eighth O-ring is sleeved outside the second cylinder barrel to seal a gap between the second cylinder barrel and the second sealing portion. A ninth O-ring is sleeved outside the piston rod to seal a gap between the piston rod and the front-end cover.

In some embodiments, the first spring, the second spring, the third spring, the fourth spring, the fifth spring, and the eighth spring are compression springs.

Compared to the prior art, the present disclosure has the following beneficial effects.

1. The readily-operable hydraulic cylinder is provided, in which the second piston is configured to push the third valve to open the oil inlet passage and the fourth valve to open the oil return passage, such that the hydraulic oil in the pressure chamber flows back to the oil storage chamber via the oil inlet passage, the second pressurizing chamber and the oil return passage, thereby enabling the downward movement of the piston rod. Thus, both the upward and downward movements of the piston rod can be achieved merely by stepping on the foot-operated assembly without separate operations, resulting in simplified operation.

2. Regarding the readily-operable hydraulic cylinder provided herein, the valve core hole is provided in the valve body. The side wall of the valve core hole is provided with the oil inlet hole and the oil outlet hole opposite to each other. The oil inlet hole and the oil outlet hole are each communicated with the oil return passage. The regulating valve core is slidably arranged in the valve core hole along the axial direction of the valve core hole. The portion of the valve core hole at the first side of the regulating valve core is communicated with the oil storage chamber, and the portion of the valve core hole at the second side of the regulating valve core is communicated with the oil inlet passage. The regulating valve core includes the truncated-cone section arranged opposite to the oil inlet port. The diameter of the truncated-cone section is increasing from the first side of the regulating valve core to the second side of the regulating valve core, thereby enabling the piston rod to descend at a constant speed under both light load and heavy load conditions.

3. Regarding the readily-operable hydraulic cylinder provided herein, the mounting hole is provided in the valve body. The second valve core is slidably provided in the mounting hole. The portion of the mounting hole at a side of the second valve core is communicated with the pressure chamber. The end of the second valve core away from the pressure chamber is connected to the first valve core. In response to a case of overloading, the second valve core is configured to push the first valve core to open the second oil passage, such that the first pressurizing chamber is relieved, thereby enabling the pedal operation for lifting under heavy load conditions to be performed with a reduced force.

4. Regarding the readily-operable hydraulic cylinder provided herein, the foot-operated assembly is designed with a foldable mechanism, where the pedal is unfolded for normal operation during use and is automatically folded when not in use to save space. Meanwhile, the hinged connection between the pedal and the second hinged seat is implemented with a self-lubricating bushing structure, thereby ensuring smooth unfolding and folding, and extending the service life.

### BRIEF DESCRIPTION OF THE DRAWINGS

FIG. 1 is a perspective view of a readily-operable hydraulic cylinder according to an embodiment of the present disclosure;

FIG. 2 is a sectional view of the readily-operable hydraulic cylinder without a foot-operated assembly and a bottom frame according to an embodiment of the present disclosure;

FIG. 3 is a partial sectional view of the readily-operable hydraulic cylinder from another perspective according to an embodiment of the present disclosure;

FIG. 4 is a perspective view of an adjusting valve core of the readily-operable hydraulic cylinder according to an embodiment of the present disclosure;

FIG. 5 is a perspective view of the foot-operated assembly, the bottom frame and a first piston of the readily-operable hydraulic cylinder according to an embodiment of the present disclosure; and

FIG. 6 is a sectional view of the first piston and a mounting seat of the readily-operable hydraulic cylinder according to an embodiment of the present disclosure.

In the figures: 1—base; 2—first cylinder barrel; 3—valve body; 4—second cylinder barrel; 5—oil storage chamber; 6—piston rod; 7—pressure chamber; 8—first piston; 9—joint; 10—second piston; 11—first pressurizing chamber; 12—second pressurizing chamber; 13—first oil passage; 14—second oil passage; 15—oil inlet passage; 16—oil return passage; 17—first valve; 17a—steel ball; 17b—seventh spring; 18—second valve; 18a—first valve core; 18b—second spring; 19—third valve; 19a—third valve core; 19b—fourth spring; 20—fourth valve; 20a—fourth valve core; 20b—fifth spring; 21—valve core hole; 22—oil inlet hole; 23—oil outlet hole; 24—adjusting valve core; 24a—truncated-cone section; 24b—first cylindrical section; 24c—second cylindrical section; 24d—first annular projection; 24e—second annular projection; 25—first spring; 26—mounting hole; 27—second valve core; 28—mounting sleeve; 29—pushing shaft; 30—third spring; 31—mounting seat; 31a—bottom plate; 31b—sleeve portion; 32—groove; 33—oil passing hole; 34—through hole; 35—sixth spring; 36—eighth spring; 37—bottom frame; 37a—first mounting plate; 37b—second mounting plate; 37c—mounting lug; 38—first hinged seat; 39—second hinged seat; 39a—hinged plate; 39b—connecting plate; 40—pedal; 41—torsion spring; 42—limit plate; 43—front end cover; 43a—first sealing portion; 43b—second sealing portion; 43c—limit projecting edge; 44—sliding post; 45—mounting flange; 46—waist-shaped hole; 47—oil discharge passage; and 48—connecting portion.

### DETAILED DESCRIPTION OF EMBODIMENTS

The technical solutions in the embodiments of the present disclosure will be described clearly and completely below in conjunction with the accompanying drawings. It is obvious that the described embodiments are merely some embodiments of the present disclosure, instead of all embodiments. Based on the embodiments in the present disclosure, all other embodiments obtained by those of ordinary skill in the art without making creative effort shall fall within the scope of the present disclosure defined by the appended claims.

An embodiment of the present disclosure provides a readily-operable hydraulic cylinder, including a housing composed of a base 1 and a first cylinder barrel 2. A valve body 3 is fixedly provided in the housing. A second cylinder barrel 4 is fixedly provided at an upper end of the valve body 3, and is located inside the first cylinder barrel 2. An oil storage chamber 5 is formed between the first cylinder barrel 2, the second cylinder barrel 4 and the valve body 3. A piston rod 6 is slidably provided inside the second cylinder barrel 4. A pressure chamber 7 is formed between the piston rod 6, the second cylinder barrel 4 and the valve body 3. A first piston 8 is slidably and vertically arranged inside the base 1. The first piston 8 is located below the valve body 3, and is configured to be driven by a foot-operated assembly to move upward. A joint 9 is provided below the valve body 3. A second piston 10 is slidably provided inside the joint 9. A first pressurizing chamber 11 is formed between the first piston 8, the valve body 3, the joint 9 and the housing. A second pressurizing chamber 12 is formed between the second piston 10, the joint 9 and the valve body 3. The first pressurizing chamber 11 is communicated with the second pressurizing chamber 12 through a first oil passage 13. A second oil passage 14, an oil inlet passage 15 and an oil return passage 16 are provided inside the valve body 3. The oil storage chamber 5 is communicated with the first pressurizing chamber 11 through the second oil passage 14. The second pressurizing chamber 12 is communicated with the pressure chamber 7 through the oil inlet passage 15. The second pressurizing chamber 12 is communicated with the oil storage chamber 5 through the oil return passage 16. A first valve 17 is provided in the first oil passage 13, where the first valve 17 is a check valve. A second valve 18 is provided in the second oil passage 14. A third valve 19 is provided in the oil inlet passage 15. A fourth valve 20 is provided in the oil return passage 16, where the fourth valve 20 is a check valve. When the piston rod 6 is required to move upward, the foot-operated assembly is configured to drive the first piston 8 to move upward to compress the first pressurizing chamber 11, such that an oil pressure in the first pressurizing chamber 11 is increased to cause the second valve 18 to be closed to block the second oil passage 14 and cause the first valve 17 to be opened to open the first oil passage 13, so as to allow a hydraulic oil in the first pressurizing chamber 11 to enter the second pressurizing chamber 12 through the first oil passage 13. During an upward movement of the first piston 8, the first piston 8 is configured to drive the second piston 10 to move upward to compress the second pressurizing chamber 12, such that an oil pressure in the second pressurizing chamber 12 is increased to cause the third valve 19 to be opened to open the oil inlet passage 15, so as to allow a hydraulic oil in the second pressurizing chamber 12 to enter the pressure chamber 7 through the oil inlet passage 15. When the piston rod 6 is required to move downward, the foot-operated assembly is configured to drive the first piston 8 to move upward until the second piston 10 pushes the third valve 19 to open the oil inlet passage 15 and the fourth valve 20 to open the oil return passage 16, such that a hydraulic oil in the pressure chamber 7 flows through the oil inlet passage 15, the second pressurizing chamber 12 and the oil return passage 16 back into the oil storage chamber 5.

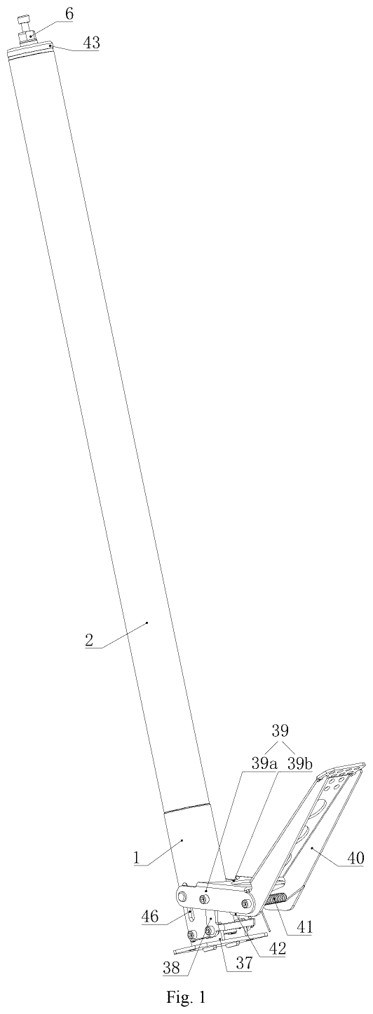

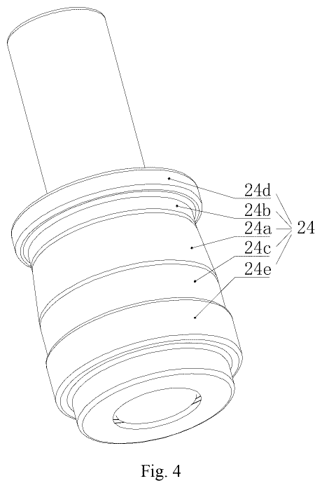

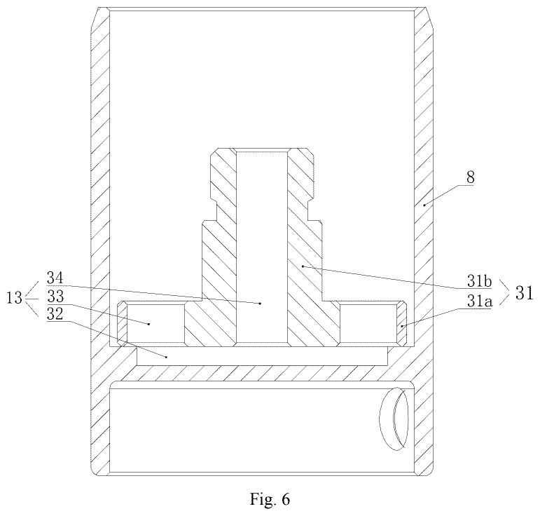

The working principle of the readily-operable hydraulic cylinder is as follows. As shown in FIGS. 1-6, when the foot-operated assembly is stepped on, the foot-operated assembly is configured to drive the first piston 8 to move upward to compress the first pressurizing chamber 11, such that the oil pressure in the first pressurizing chamber 11 is increased to cause the second valve 18 to be closed to block the second oil passage 14 and cause the first valve 17 to be opened to open the first oil passage 13, so as to allow the hydraulic oil in the first pressurizing chamber 11 to enter the second pressurizing chamber 12 through the first oil passage 13. During the upward movement of the first piston 8, the first piston 8 is configured to drive the second piston 10 to move upward to compress the second pressurizing chamber 12, such that the oil pressure in the second pressurizing chamber 12 is increased to cause the third valve 19 to be opened to open the oil inlet passage 15, so as to allow the hydraulic oil in the second pressurizing chamber 12 to enter the pressure chamber 7 through the oil inlet passage 15, thereby driving the piston rod 6 upward. Subsequently, when the foot-operated assembly is pressed with greater force, the foot-operated assembly is configured to drive the first piston 8 to move upward until the second piston 10 pushes the third valve 19 to open the oil inlet passage 15 and the fourth valve 20 to open the oil return passage 16, such that the hydraulic oil in the pressure chamber 7 flows through the oil inlet passage 15, the second pressurizing chamber 12, and the oil return passage 16 back into the oil storage chamber 5, thereby causing the piston rod 6 to descend slowly.

The readily-operable hydraulic cylinder provided herein features a compact structure and simple operation, where the piston rod 6 can be moved upward and downward merely by stepping on the foot-operated assembly, without the need for separate operations.

Under heavy load conditions, due to a high oil pressure in the pressure chamber 7, the hydraulic oil in the oil return passage 16 flows at an increased rate, which may cause the piston rod 6 to descend more rapidly.

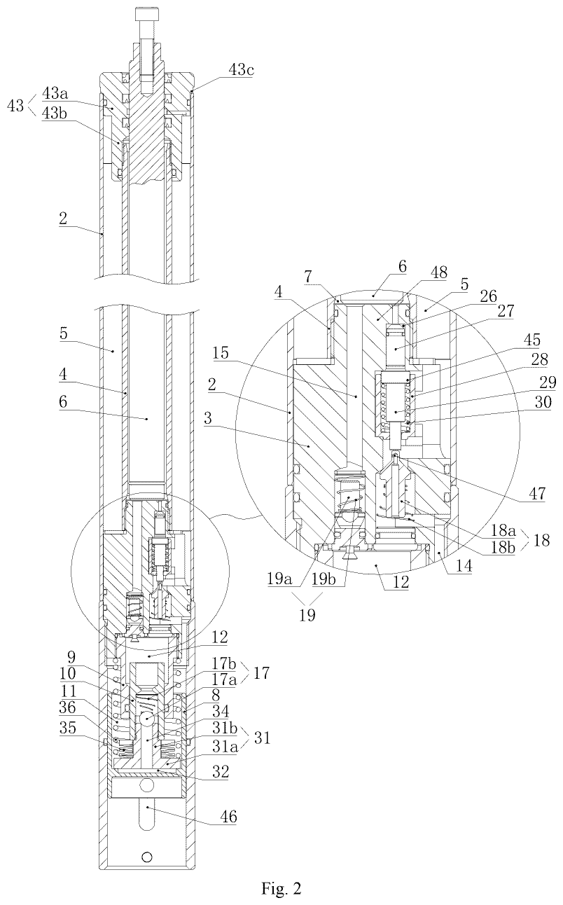

In order to prevent the piston rod 6 from descending at an accelerated rate under heavy load conditions due to high oil pressure, as shown in FIGS. 2-4, a valve core hole 21 is provided in the valve body 3. A side wall of the valve core hole 21 is provided with an oil inlet hole 22 and an oil outlet hole 23 opposite to each other. The oil inlet hole 22 and the oil outlet hole 23 are each communicated with the oil return passage 16. A regulating valve core 24 is slidably arranged in the valve core hole 21 along an axial direction of the valve core hole 21. A portion of the valve core hole 21 at a first side of the regulating valve core 24 is communicated with the oil storage chamber 5, and a portion of the valve core hole 21 at a second side of the regulating valve core is communicated with the oil inlet passage 15. The regulating valve core 24 includes a truncated-cone section 24a arranged opposite to the oil inlet hole 22. A diameter of the truncated-cone section 24a is increasing from the first side of the regulating valve core 24 to the second side of the regulating valve core 24. Under heavy load conditions, the oil pressure in the pressure chamber 7 is relatively high, i.e., the oil pressure in the oil inlet passage 15 is relatively high. The regulating valve core 24 is pushed by the oil pressure in the oil inlet passage 15 to move toward a side where the oil storage chamber 5 is located. A diameter of a portion of the truncated-cone section 24a opposite to the oil inlet hole 22 increases, thereby reducing the effective area through which hydraulic oil flows from the oil return passage 16 into the oil inlet hole 22 and the effective area through which hydraulic oil exits via the oil outlet hole 23 into the oil storage chamber 5. In this way, the volume of hydraulic oil flowing from the pressure chamber 7 back to the oil storage chamber 5 remains unchanged, enabling the piston rod 6 to descend at a constant speed under heavy load conditions. Consequently, the piston rod 6 can descend at a constant speed under both light load and heavy load conditions.

In order to enable the piston rod 6 to descend rapidly under a no-load condition, a first spring 25 is provided in the valve core hole 21 to offer an elastic force to cause the regulating valve core 24 to move toward a side where the oil inlet passage 15 is located. The regulating valve core 24 further includes a first cylindrical section 24b whose diameter is equal to a minimum diameter of the truncated-cone section 24a and a second cylindrical section 24c whose diameter is equal to a maximum diameter of the truncated-cone section 24a. The first cylindrical section 24b is connected to a portion of the truncated-cone section 24a having the minimum diameter, and the second cylindrical section 24c is connected to a portion of the truncated-cone section 24a having the maximum diameter. The regulating valve core 24 is provided with a first annular projection 24d and a second annular projection 24e. The first annular projection 24d and the second annular projection 24e abut against the side wall of the valve core hole 21 for sealing. The first annular projection 24d is located on a side of the first cylindrical section 24b away from the truncated-cone section 24a, and the second annular projection 24e is located on a side of the second cylindrical section 24c away from the truncated-cone section 24a.

In some embodiments, the valve core hole 21 is axially arranged in a vertical direction and includes a first valve core hole and a second valve core hole. The first valve core hole is larger than the second valve core hole. The regulating valve core 24 and the first spring 25 are provided in the first valve core hole. An upper end of the first valve core hole is communicated with the oil storage chamber 5. A sliding post 44 is provided inside the regulating valve core 24. An upper end of the sliding post 44 is inserted into the regulating valve core 24, and a lower end of the sliding post 44 is slidably arranged in the second valve core hole. A lower end of the second valve core hole is communicated with the oil inlet passage 15.

To improve the sealing of a gap between the sliding post 44 and the second valve core hole, a first O-ring is sleeved outside the sliding post 44 to seal the gap therebetween.

FIG. 2 shows a structure of the second valve 18. The second valve 18 includes a first valve core 18a configured to block and open the second oil passage 14 and a second spring 18b configured to elastically reset the first valve core 18a toward a side where the oil storage chamber 5 is located. A mounting hole 26 is provided in the valve body 3. A second valve core 27 is slidably provided in the mounting hole 26. A portion of the mounting hole 26 at a side of the second valve core 27 is communicated with the pressure chamber 7. An end of the second valve core 27 away from the pressure chamber 7 is connected to the first valve core 18a. In response to a case of overloading, the second valve core 27 pushes the first valve core 18a to open the second oil passage 14, such that the first pressurizing chamber 11 is relieved, thereby enabling the pedal operation for lifting under heavy load conditions to be performed with a reduced force. Specifically, when a pressure in the pressure chamber 7 is high under heavy load conditions, an oil pressure in the pressure chamber 7 drives the second valve core 27 to move toward a side of the first valve core 18a and push the first valve core 18a to open the second oil passage 14. As a result, during the upward movement of the first piston 8, the hydraulic oil in the first pressurizing chamber 11 flows back to the oil storage chamber 5 through the second oil passage 14, thereby relieving the pressure in the first pressurizing chamber 11. At this time, the first valve 17 is closed to block the first oil passage 13, preventing the hydraulic oil in the first pressurizing chamber 11 from entering the second pressurizing chamber 12, which reduces the hydraulic oil entering the pressure chamber 7 and facilitates the upward movement of the first piston 8 and the second piston 10 with less effort, although it requires repeatedly stepping on the foot-operated assembly multiple times.

Under light load conditions, the first pressurizing chamber 11 and the second pressurizing chamber 12 operate simultaneously, such that the piston rod 6 can rise rapidly.

A connection structure between the second valve core 27 and the first valve core 18a as shown in FIG. 2. The valve body 3 is further provided with a mounting sleeve 28. A pushing shaft 29 is slidably provided in the mounting sleeve 28, and is located between the second valve core 27 and the first valve core 18a. The pushing shaft 29 is sleeved with a third spring 30 configured to cause the pushing shaft 29 to move toward a side where the second valve core 27 is located.

Mounting structures of the pushing shaft 29 and the third spring 30 are as follows. The mounting hole 26 is axially arranged in the vertical direction. An upper end of the mounting sleeve 28 has an opening. A mounting hole is provided on a lower end surface of the mounting sleeve 28 for the pushing shaft 29 to extend therethrough. A mounting flange 45 is provided at an upper end of the pushing shaft 29. An upper end of the third spring 30 is configured to abut against the mounting flange 45, and a lower end of the third spring 30 is configured to abut against the lower end surface of the mounting sleeve 28.

A second O-ring is sleeved outside the second valve core 27 to seal a gap between the second valve core 27 and the mounting hole 26.

Under a no-load condition, after the piston rod 6 reaches the top, the pressure chamber 7 is fully filled with the hydraulic oil, and the hydraulic oil in the second pressurizing chamber 12 can no longer enter the pressure chamber 7. When the foot-operated assembly is further depressed, the oil pressure in the second pressurizing chamber 12 pushes the oil return valve 18 to open the oil return passage 16, allowing the hydraulic oil in the second pressurizing chamber 12 to flow through the oil return passage 16 into the oil storage chamber 5. The oil pressure in the first pressurizing chamber 11 pushes the first valve 17 to open the first oil passage 13, such that the hydraulic oil in the first pressurizing chamber 11 flows through the first oil passage 13 into the second pressurizing chamber 12.

To reduce the force required to operate the pedal under the no-load condition, an oil discharge passage 47 is provided in the first valve core 18a, and is configured to communicate the oil storage chamber 5 with the first pressurizing chamber 11. When pressure relief is needed under the no-load condition, the hydraulic oil in the first pressurizing chamber 11 flows back to the oil storage chamber 5 through the oil discharge passage 47, thereby reducing the amount of hydraulic oil flowing from the second pressurizing chamber 12 into the oil storage chamber 5 through the oil return passage 16.

A structure of the oil discharge passage 47 is as follows. The first valve core 18a is axially arranged in the vertical direction. The oil discharge passage 47 includes a first hole extending along an axis direction of the first valve core 18a and a second hole extending perpendicular to the axis direction of the first valve core 18a. The first hole is vertical, and the second hole is horizontal. A diameter of the second hole is 0.6-0.8 mm. The first hole is a stepped hole, including a third hole located above and a fourth hole located below the third hole. The fourth hole is larger than the third hole. The second hole is connected to a side wall of the third hole. A diameter of the third hole is 1.0-1.4 mm, and a diameter of the fourth hole is 2.0-2.4 mm. The oil flow through the oil discharge passage 47 is much smaller than that through the second oil passage 14 that is opened when the second valve core 27 pushes the first valve core 18a, thereby exerting only a minor influence on the amount of oil entering the pressure chamber 7 during the upward movement of the piston rod 6.

In this embodiment, the diameter of the second hole is 0.7 mm, the diameter of the third hole is 1.2 mm and the diameter of the fourth hole is 2.2 mm.

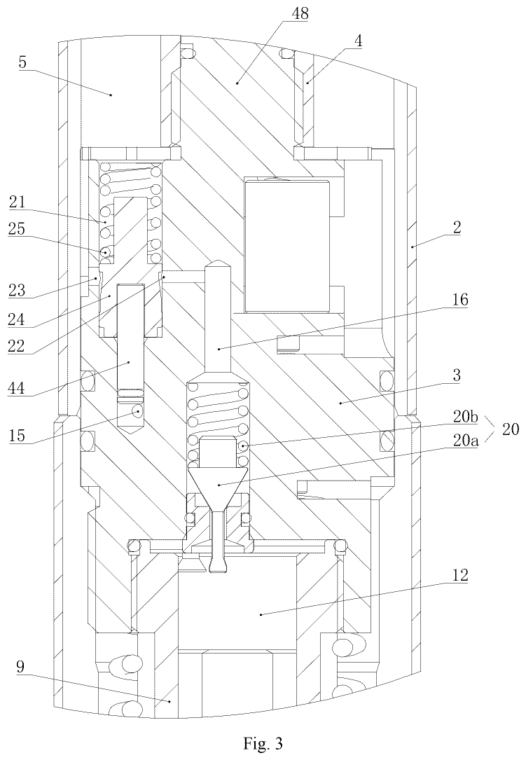

Specific structures of the third valve 19 and the fourth valve 20 are as follows. As shown in FIGS. 2-3, the third valve 19 includes a third valve core 19a configured to block and open the oil inlet passage 15 and a fourth spring 19b configured to cause the third valve core 19a to reset toward a side where the second pressurizing chamber 12 is located. An end of the third valve core 19a adjacent to the second pressurizing chamber 12 is configured to extend out of the valve body 3. The fourth valve 20 includes a fourth valve core 20a configured to block and open the oil return passage 16 and a fifth spring 20b configured to cause the fourth valve core 20a to reset toward the side of the second pressurizing chamber 12. An end of the fourth valve core 20a adjacent to the second pressurizing chamber 12 is configured to extend out of the valve body 3. An elastic force of the fourth spring 19b is much smaller than that of the fifth spring 20b. When the second piston 10 moves upward to push the third valve core 19a and the fourth valve core 20a into the valve body 3, the third valve core 19a is configured to open the oil inlet passage 15 and the fourth valve core 20a is configured to open the oil return passage 16.

When the second piston 10 does not push the third valve core 19a and the fourth valve core 20a to move into the valve body 3, due to the elastic force of the fourth spring 19b being much smaller than that of the fifth spring 20b, the oil pressure in the second pressurizing chamber 12 is normally only sufficient to open the third valve core 19a to open the oil inlet passage 15, but insufficient to open the fourth valve core 20a to open the oil return passage 16.

In some embodiments, the elastic force of the fifth spring 20b is at least ten times that of the fourth spring 19b. In this embodiment, the elastic force of the fifth spring 20b is 100 N, while the elastic force of the fourth spring 19b is 6 N.

Structures of the first piston 8 and the first oil passage 13 are as follows. As shown in FIGS. 2, 3 and 6, the first piston 8 is configured as an upward-opening hollow cylinder. A mounting seat 31 is provided inside the first piston 8. The mounting seat 31 includes a bottom plate 31a and a sleeve portion 31b on the bottom plate 31a. An inner end surface of the first piston 8 is configured to recess to form a groove 32. The bottom plate 31a is provided with an oil passing hole 33 configured to communicate the first pressurizing chamber 11 with the groove 32. An upper end of the sleeve portion 31b is fixedly connected to a lower end of the second piston 10, and is provided inside the second piston 10. The mounting seat 31 is provided with a through hole 34 configured to communicate the groove 32 with the second pressurizing chamber 12. The oil passage hole 33, the groove 32 and the through hole 34 together form the first oil passage 13. The first valve 17 is provided in the through hole 34. A sixth spring 35 is sleevedly provided on the sleeve portion 31b, and is located between the second piston 10 and the bottom plate 31a. When the second piston 10 pushes the third valve 19 and the fourth valve 20, a lower end of the joint 9 abuts against the sixth spring 35, such that a foot force required for lowering the piston rod 6 is greater than that for raising the piston rod 6, thereby enabling the operator to distinguish between pedal actions for lifting and lowering the piston rod 6.

The sleeve portion 31b is threadedly connected with the second piston 10.

A structure of the first valve 17 is as follows. The through hole 34 is arranged axially in the vertical direction. The first valve 17 includes a steel ball 17a provided on the mounting seat 31 for blocking and opening the through hole 34, and a seventh spring 17b configured to offer an elastic force to cause the steel ball 17a to reset downward. In some embodiments, the sixth spring 35 is a Belleville-spring washer.

For improved sealing performance, a third O-ring is sleeved outside the first piston 8 to seal a gap between the first piston 8 and the base 1, and a fourth O-ring is sleeved outside the second piston 10 to seal a gap between the second piston 10 and the joint 9.

For improved sealing performance, a lower end of the valve body 3 is threadedly connected to an upper end of the base 1. An upper end of the valve body 3 is located inside the first cylinder barrel 2. A fifth O-ring is sleeved outside the valve body 3 to seal a gap between the base 1 and the valve body 3. A sixth O-ring is sleeved outside the valve body 3 to seal a gap between the first cylinder barrel 2 and the valve body 3.

To enable the mounting seat 31 and the first piston 8 to automatically reset downward when the foot-operated assembly is released, an eighth spring 36 is sleeved outside the joint 9. An upper end of the eighth spring 36 is configured to abut against the valve body 3, and a lower end of the eighth spring 36 is configured to abut against the bottom plate 31a. When the foot-operated assembly is released, the bottom plate 31a moves downward under the elastic force of the eighth spring 36, thereby driving the mounting seat 31 and the second piston 10 to move downward. The spaces of the first pressurizing chamber 11 and the second pressurizing chamber 12 are enlarged, the second valve 18 is opened to open the second oil passage 14, and the first valve 17 is opened to open the first oil passage 13, such that the hydraulic oil in the oil storage chamber 5 flows through the second oil passage 14 into the first pressurizing chamber 11, and then through the first oil passage 13 into the second pressurizing chamber 12.

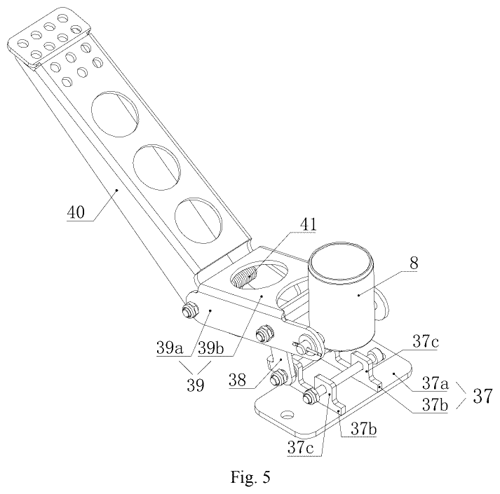

To reduce the lateral space occupied by the foot-operated assembly, as shown in FIGS. 1 and 5, a bottom frame 37 is provided below the base 1. The foot-operated assembly includes a first hinged seat 38. A lower end of the first hinged seat 38 is hinged to the bottom frame 37. An upper end of the first hinged seat 38 is hinged to a second hinged seat 39. A first end of the second hinged seat 39 is hinged to the first piston 8, and a second end of the second hinged seat 39 is hinged to an end of a pedal 40. A torsion spring 41 is sleeved on a hinge shaft between the second hinged seat 39 and the pedal 40 to cause the pedal 40 to rotate upward. A limit plate 42 is provided at the end of the pedal 40 hinged to the second hinged seat 39 to abut against and limit the second hinged seat 39. When the pedal 40 is stepped on, the pedal 40 rotates downward around the hinge shaft between the second hinged seat 39 and the pedal 40 until the limit plate 42 abuts against the second hinged seat 39. Further stepping on the pedal 40 causes an end of the second hinged seat 39 hinged to the first piston 8 to move upward around a hinge shaft between the second hinged seat 39 and the first hinged seat 38, thereby driving the first piston 8 to move upward. When released, the pedal 40 is rotated upward by the elastic force of the torsion spring 41 to return to its original position, thereby completing retraction of the pedal 40.

The pedal assembly provided herein adopts a foldable mechanism design.

During operation, the pedal 40 is unfolded for normal use, and when not in operation, the pedal 40 is automatically folded to save space.

In some embodiments, the hinge connection between the pedal 40 and the second hinged seat 39 adopts a self-lubricating bushing structure, which enables smooth unfolding and folding while prolonging service life.

The hinge structure between the second hinged seat 39 and the first piston 8 is as follows. The first piston 8 further includes a connecting sleeve provided below the cylinder body. The base 1 is provided with two waist-shaped holes 46 arranged opposite to each other, where a length direction of the waist-shaped hole is arranged to be the vertical direction. The second hinged seat 39 includes two hinged plates 39a respectively located on two sides of the base 1 and a connecting plate 39b connecting the two hinged plates 39a. A hinge shaft between the second hinged seat 39 and the first piston 8 sequentially passes through one of the hinged plates 39a, one of the waist-shaped holes 46, the connecting sleeve, the other of the waist-shaped holes 46 and the other of the hinged plates 39a.

A structure of the bottom frame 37 is as follows. The bottom frame 37 includes a first mounting plate 37a and two second mounting plates 37b. The first mounting plate is horizontal, and the second mounting plates are vertical. Each second mounting plate 37b is provided with two mounting lugs 37c. A lower end of the first hinged seat 38 is hinged to one of the mounting lugs 37c, and the other mounting lug 37c is configured to extend into the base 1 to be hinged to the base 1. A gap of 0.8-1.2 mm is provided between a bottom surface of the base 1 and the second mounting plates 37b, thereby allowing the base 1 to make a slight rotation with respect to the bottom frame 37.

In some embodiments, a front-end cover 43 is provided at an upper end of the first cylinder barrel 2. The front-end cover 43 includes a first sealing portion 43a and a second sealing portion 43b. The first sealing portion 43a is provided inside the first cylinder barrel 2. An outer side wall of the first sealing portion 43a is in sealing contact with an inner side wall of the first cylinder barrel 2. An upper end of the second cylinder barrel 4 is provided inside the second sealing portion 43b. An inner side wall of the second sealing portion 43b is in sealing contact with an outer side wall of the second cylinder barrel 4. An upper end of the piston rod 6 is configured to extend out of the front-end cover 43. An outer side wall of the piston rod 6 is configured to abut against an inner side wall of the front-end cover 43 for sealing.

The mounting structures of the first cylinder barrel 2 and the second cylinder barrel 4 are as follows. A connecting portion 48 is provided at a middle of an upper end of the valve body 3. The upper end of the second cylinder barrel 4 is threadedly connected to the second sealing portion 43b, and a lower end of the second cylinder barrel 4 is threadedly connected to the connecting portion 48. A limit projecting edge 43c is provided on a periphery of the first sealing portion 43a. The first cylinder barrel 2 is axially limited between the limit projecting edge 43c and the base 1.

For improving sealing, a seventh O-ring is sleeved outside the first sealing portion 43a to seal a gap between the first cylinder barrel 2 and the first sealing portion 43a. An eighth O-ring is sleeved outside the second cylinder barrel 4 to seal a gap between the second sealing portion 43b and the second cylinder barrel 4. A ninth O-ring is sleeved outside the piston rod 6 to seal a gap between the piston rod 6 and the front-end cover 43.

In some embodiments, the first spring 25, the second spring 18b, the third spring 30, the fourth spring 19b, the fifth spring 20b and the eighth spring 36 are all compression springs.

In the present disclosure, the pedal force and the lifting speed can be automatically switched between the light load and heavy load conditions. For safety, the piston rod 6 can descend at a constant speed.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A hydraulic cylinder, comprising:
a housing composed of a base and a first cylinder barrel;
wherein a valve body is fixedly provided in the housing; a second cylinder barrel is fixedly provided at an upper end of the valve body, and is located inside the first cylinder barrel; and an oil storage chamber is formed between the first cylinder barrel, the second cylinder barrel and the valve body;
a piston rod is slidably provided inside the second cylinder barrel; and a pressure chamber is formed between the piston rod, the second cylinder barrel and the valve body;
a first piston is slidably and vertically arranged inside the base; and the first piston is located below the valve body, and is configured to be driven by a foot-operated assembly to move upward;
a joint is provided below the valve body; a second piston is slidably provided inside the joint; a first pressurizing chamber is formed between the first piston, the valve body, the joint and the housing; and a second pressurizing chamber is formed between the second piston, the joint and the valve body;
the first pressurizing chamber is communicated with the second pressurizing chamber through a first oil passage;
a second oil passage, an oil inlet passage and an oil return passage are provided inside the valve body; the oil storage chamber is communicated with the first pressurizing chamber through the second oil passage; the second pressurizing chamber is communicated with the pressure chamber through the oil inlet passage; and the second pressurizing chamber is communicated with the oil storage chamber through the oil return passage;
a first valve is provided in the first oil passage, wherein the first valve is a check valve; a second valve is provided in the second oil passage; a third valve is provided in the oil inlet passage; and a fourth valve is provided in the oil return passage, wherein the fourth valve is a check valve;
in response to a case that the piston rod is required to move upward, the foot-operated assembly is configured to drive the first piston to move upward to compress the first pressurizing chamber, such that an oil pressure in the first pressurizing chamber is increased to cause the second valve to be closed to block the second oil passage and cause the first valve to be opened to open the first oil passage, so as to allow a hydraulic oil in the first pressurizing chamber to enter the second pressurizing chamber through the first oil passage;
during an upward movement of the first piston, the first piston is configured to drive the second piston to move upward to compress the second pressurizing chamber, such that an oil pressure in the second pressurizing chamber is increased to cause the third valve to be opened to open the oil inlet passage, so as to allow a hydraulic oil in the second pressurizing chamber to enter the pressure chamber through the oil inlet passage; and
in response to a case that the piston rod is required to move downward, the foot-operated assembly is configured to drive the first piston to move upward until the second piston pushes the third valve to open the oil inlet passage and the fourth check valve to open the oil return passage, such that a hydraulic oil in the pressure chamber flows through the oil inlet passage, the second pressurizing chamber and the oil return passage back into the oil storage chamber.

2. The hydraulic cylinder according to claim 1, wherein a valve core hole is provided in the valve body; a side wall of the valve core hole is provided with an oil inlet hole and an oil outlet hole opposite to each other; and the oil inlet hole and the oil outlet hole are each communicated with the oil return passage;
a regulating valve core is slidably provided in the valve core hole along an axial direction of the valve core hole;
a portion of the valve core hole at a first side of the regulating valve core is communicated with the oil storage chamber, and a portion of the valve core hole at a second side of the regulating valve core is communicated with the oil inlet passage;
the regulating valve core comprises a truncated-cone section arranged opposite to the oil inlet hole; and
a diameter of the truncated-cone section is increasing from the first side of the regulating valve core to the second side of the regulating valve core.

3. The hydraulic cylinder according to claim 2, wherein a spring is provided in the valve core hole to offer an elastic force to cause the regulating valve core to move toward a side where the oil inlet passage is located;
the regulating valve core further comprises a first cylindrical section whose diameter is equal to a minimum diameter of the truncated-cone section and a second cylindrical section whose diameter is equal to a maximum diameter of the truncated-cone section;
the first cylindrical section is connected to a portion of the truncated-cone section having the minimum diameter, and the second cylindrical section is connected to a portion of the truncated-cone section having the maximum diameter;
the regulating valve core is provided with a first annular projection and a second annular projection; and the first annular projection and the second annular projection abut against the side wall of the valve core hole for sealing; and
the first annular projection is located on a side of the first cylindrical section away from the truncated-cone section, and the second annular projection is located on a side of the second cylindrical section away from the truncated-cone section.

4. The hydraulic cylinder according to claim 1, wherein the second valve comprises a first valve core configured to open and block the second oil passage, and a first spring configured to elastically reset the first valve core toward a side where the oil storage chamber is located;
a mounting hole is provided in the valve body; a second valve core is slidably provided in the mounting hole; a portion of the mounting hole at a side of the second valve core is communicated with the pressure chamber; and an end of the second valve core away from the pressure chamber is connected to the first valve core; and
in response to a case of overloading, the second valve core is configured to push the first valve core to open the second oil passage.

5. The hydraulic cylinder according to claim 4, wherein the valve body is further provided with a mounting sleeve; a pushing shaft is slidably provided in the mounting sleeve, and is located between the second valve core and the first valve core; and the pushing shaft is sleeved with a second spring configured to cause the pushing shaft to move toward a side where the second valve core is located.

6. The hydraulic cylinder according to claim 4, wherein an oil discharge passage is provided in the first valve core, and is configured to communicate the oil storage chamber with the first pressurizing chamber.

7. The hydraulic cylinder according to claim 1, wherein the third valve comprises a first valve core configured to open and block the oil inlet passage and a first spring configured to cause the first valve core to reset toward a side where the second pressurizing chamber is located;
an end of the first valve core adjacent to the second pressurizing chamber is configured to extend out of the valve body;
the fourth check valve comprises a second valve core configured to open and block the oil return passage and a second spring configured to cause the second valve core to reset toward the side of the second pressurizing chamber;
an end of the second valve core adjacent to the second pressurizing chamber is configured to extend out of the valve body;
an elastic force of the first spring is smaller than that of the second spring; and
in response to a case that the second piston moves upward to push the first valve core and the second valve core to move into the valve body, the first valve core is configured to open the oil inlet passage, and the second valve core is configured to open the oil return passage.

8. The hydraulic cylinder according to claim 1, wherein the first piston is configured as an upward-opening hollow cylinder;
a mounting seat is provided inside the first piston; and the mounting seat comprises a bottom plate and a sleeve portion on the bottom plate;
an inner end surface of the first piston is configured to recess to form a groove;
the bottom plate is provided with an oil passage hole configured to communicate the first pressurizing chamber with the groove;
an upper end of the sleeve portion is fixedly connected to a lower end of the second piston, and is provided inside the second piston;
the mounting seat is provided with a through hole configured to communicate the groove with the second pressurizing chamber;
the oil passage hole, the groove and the through hole together form the first oil passage;
the first check valve is provided in the through hole;
a first spring is sleevedly provided on the sleeve portion, and is located between the second piston and the bottom plate; and
in response to a case that the second piston pushes the third valve and the fourth check valve, a lower end of the joint abuts against the first spring.

9. The hydraulic cylinder according to claim 8, wherein a second spring is sleeved outside the joint; and an upper end of the second spring is configured to abut against the valve body, and a lower end of the second spring is configured to abut against the bottom plate.

10. The hydraulic cylinder according to claim 1, wherein a bottom frame is provided below the base;
the foot-operated assembly comprises a first hinged seat; a lower end of the first hinged seat is hinged to the bottom frame; and an upper end of the first hinged seat is hinged to a second hinged seat;
a first end of the second hinged seat is hinged to the first piston, and a second end of the second hinged seat is hinged to an end of a pedal;
a torsion spring is sleeved on a hinge shaft between the second hinged seat and the pedal to cause the pedal to rotate upward; and
a limit plate is provided at the end of the pedal hinged to the second hinged seat to abut against and limit the second hinged seat.
